(19) United States
(12) Patent Application Publication
(10) Pub. No.: US 2010/0229007 A1
(43) Pub. Date: Sep. 9, 2010

(54) Nonvolatile Memory Device and Operating Method Thereof

(76) Inventor: Junghoon Park, Hwaseong-si (KR)

Correspondence Address: MYERS BIGEL SIBLEY & SAJOVEC, PO BOX 37428, RALEIGH, NC, 27627, US

(21) Appl. No.: 12/711,720

(22) Filed: Feb. 24, 2010

(30) Foreign Application Priority Data
Mar. 4, 2009 (KR) 10-2009-0018568

(51) Int. Cl. G06F 12/14

(52) U.S. Cl. 713/193; 711/103; 711/E12.092

(57) ABSTRACT

An operating method of a non-volatile memory device includes randomizing source data to form randomized source data, storing the randomized source data, generating a seed based on an address, generating a random data sequence based on the seed, and de-randomizing the randomized data using the random data sequence. Related nonvolatile memory devices and methods of reading data stored in non-volatile memory devices are also disclosed.

### CROSS-REFERENCE TO RELATED APPLICATIONS

The present application claims priority under 35 U.S.C §119 to Korean Patent Application No. 10-2009-0018568 filed Mar. 4, 2009, the disclosure of which is incorporated herein by reference.

### BACKGROUND

The present invention relates to non-volatile memory devices, and more particularly, the present invention relates to non-volatile memory devices configured to randomize data and to store the randomized data.

Non-volatile memory devices may include flash memory devices, resistance variable memory devices, and the like. In general, flash memory devices include NAND flash memory devices and NOR flash memory devices. A NOR flash memory device may have a structure in which memory cells are connected in parallel with each bit line. This means that memory cells in a NOR flash memory device are accessed individually. NAND flash memory devices have a structure in which memory cells are connected in series with each bit line. Memory cells connected in series with one bit line may form a cell string that may be accessed using a single contact. This means that the NAND flash memory device may be more advantageous for high integration.

In recent years, there has been conducted a research on a technique where a plurality of data bits is stored in one memory cell, to increase the degree of integration of the flash memory device. A memory cell capable of storing plural data bits may be called a multi-level cell (MLC). As contrasted with the MLC, a memory cell capable of storing only a single data bit may be called a single-level cell (SLC).

### SUMMARY

A method of operating a non-volatile memory device according to some embodiments includes randomizing source data to generate randomized source data, storing the randomized source data in the non-volatile memory device, generating a seed based on a memory address, generating a random data sequence in response to the seed, and de-randomizing the randomized source data using the random data sequence.

A non-volatile memory device according to some embodiments includes a memory cell array configured to store data, a page buffer circuit connected to the memory cell array, and a random data interface circuit configured to increment an address input in connection with a cache read operation and to de-randomize stored data read by the page buffer circuit using the incremented address as a seed.

A method of reading data stored in a non-volatile memory device according to some embodiments includes receiving a first read command and an initial address, reading first data from a memory cell array in response to the initial address, de-randomizing the first data using a first random data sequence generated in response to the initial address, receiving a second read command, generating an internal address based on the initial address, reading second data from the memory cell array in response to the internal address, and de-randomizing the second data using a second random data sequence generated in response to the internal address.

### BRIEF DESCRIPTION OF THE DRAWINGS

The above and other objects and features of the present invention will become apparent from the following description with reference to the following figures, wherein like reference numerals refer to like parts throughout the various figures unless otherwise specified, and wherein

FIG. 1 is a block diagram schematically showing a memory device according to some embodiments.

FIG. 2 is a block diagram schematically showing a random data interface circuit in FIG. 1.

FIG. 3 is a block diagram schematically showing a random sequence generator in FIG. 2.

FIG. 4 is a diagram for describing a randomization operation of a memory device according to some embodiments.

FIG. 5 is a diagram for describing operations of a memory device according to some embodiments.

FIG. 6 is a flowchart showing a write operations of a memory device according to some embodiments.

FIG. 7 is a flowchart showing read operations of a memory device according to some embodiments.

FIG. 8 is a block diagram schematically showing a computing system including a memory device according to some embodiments.

FIG. 9 is a block diagram schematically showing a memory-based storage device including a memory device according to some embodiments.

### DETAILED DESCRIPTION OF THE EMBODIMENTS

The inventive concept is described more fully hereinafter with reference to the accompanying drawings, in which embodiments of the inventive concept are shown. This inventive concept may, however, be embodied in many different forms and should not be construed as limited to the embodiments set forth herein. Rather, these embodiments are provided so that this disclosure will be thorough and complete, and will fully convey the scope of the inventive concept to those skilled in the art. In the drawings, the size and relative sizes of layers and regions may be exaggerated for clarity. Like numbers refer to like elements throughout.

It will be understood that, although the terms first, second, third etc. may be used herein to describe various elements, components, regions, layers and/or sections, these elements, components, regions, layers and/or sections should not be limited by these terms. These terms are only used to distinguish one element, component, region, layer or section from another region, layer or section. Thus, a first element, component, region, layer or section discussed below could be termed a second element, component, region, layer or section without departing from the teachings of the inventive concept.

Spatially relative terms, such as “beneath”, “below”, “lower”, “under”, “above”, “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” or “under” other elements or features would then be oriented “above” the other elements or features. Thus, the exemplary terms “below” and “under” can encompass both an orientation of above and below. The device may be otherwise oriented (rotated 90 degrees or at other orientations) and the spatially relative descriptors used herein interpreted accordingly. In addition, it will also be understood that when a layer is referred to as being “between” two layers, it can be the only layer between the two layers, or one or more intervening layers may also be present.

The terminology used herein is for the purpose of describing particular embodiments only and is not intended to be limiting of the inventive concept. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items.

It will be understood that when an element or layer is referred to as being “on”, “connected to”, “coupled to”, or “adjacent to” another element or layer, it can be directly on, connected, coupled, or adjacent to the other element or layer, or intervening elements or layers may be present. In contrast, when an element is referred to as being “directly on,” “directly connected to”, “directly coupled to”, or “immediately adjacent to” another element or layer, there are no intervening elements or layers present.

Unless otherwise defined, all terms (including technical and scientific terms) used herein have the same meaning as commonly understood by one of ordinary skill in the art to which this inventive concept belongs. It will be further understood that terms, such as those defined in commonly used dictionaries, should be interpreted as having a meaning that is consistent with their meaning in the context of the relevant art and/or the present specification and will not be interpreted in an idealized or overly formal sense unless expressly so defined herein.

An increase in memory integration may cause an increase in interference between memory cells. That is, the interference experienced in a particular memory cell may increase or decrease according to states (that is, stored data values) of adjacent memory cells. This interference may be reduced by randomizing data being programmed into the memory cells. Embodiments of the inventive concept will be described in the context of a flash memory device. However, the inventive concept may be applied to reduce the interference between memory cells due to integration of other types of memory devices. Accordingly, the inventive concept is not limited to a flash memory device. In general, memory cells of a flash memory device may experience program voltage disturb, pass voltage disturb, F-poly coupling, and the like.

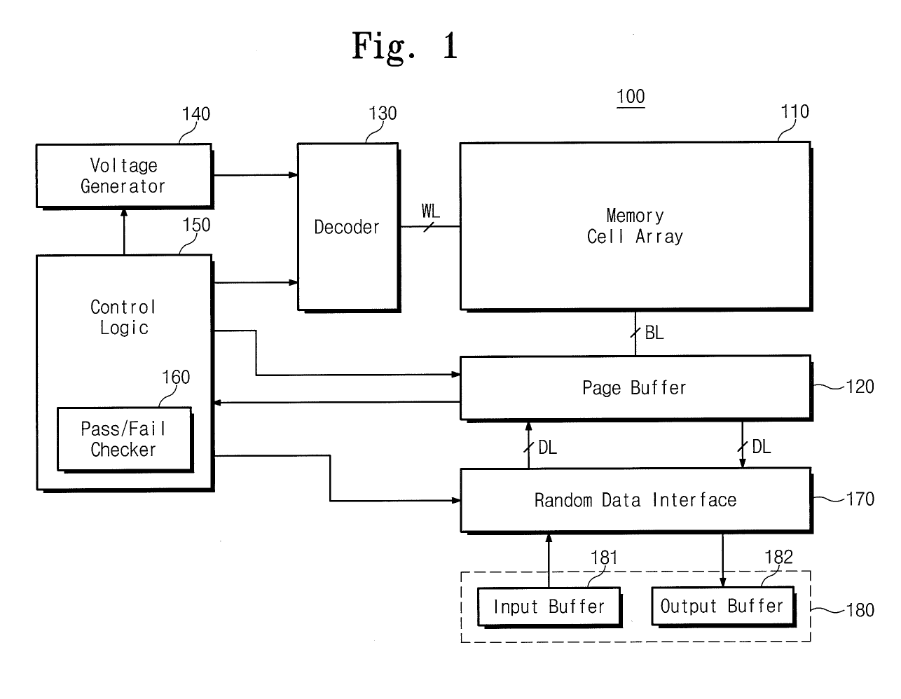

FIG. 1 is a block diagram schematically showing a memory device according to some embodiments.

Referring to FIG. 1, a memory device 100 may in some embodiments be a flash memory device. However, the memory device 100 may include any memory device in which interference occurs between memory cells due to an increased degree of integration (i.e., more dense integration in which memory cells are more closely packed together).

The memory device 100 may include a memory cell array 110 which stores M-bit data information (M being an integer). The memory cell array 110 may be divided into a plurality of regions, which includes a data region for storing user data and a spare region, for example. Each region of the memory cell array 110 may be formed of a plurality of memory blocks. An example of a memory block structure is disclosed in U.S. Pat. No. 6,236,594 entitled “FLASH MEMORY DEVICE INCLUDING CIRCUITRY FOR SELECTING A MEMORY BLOCK”, the disclosure of which is incorporated herein by reference.

The memory device 100 may further comprise a page buffer circuit 120, a decoder circuit 130, a voltage generator circuit 140, control logic 150 including a pass/fail checking circuit 160, a random data interface circuit 170, and an input/output buffer circuit 180. In some embodiments, the pass/fail checking circuit 160 can be configured independently from the control logic 150.

The page buffer circuit 120 may be controlled by the control logic 150 and may be configured to read/program data from/in the memory cell array 110. The decoder circuit 130 may be controlled by the control logic 150 and may be configured to select a memory block in the memory cell array 110 and to select a word line in the selected memory block. The selected word line may be driven by a word line voltage from the voltage generator circuit 140. The voltage generator circuit 140 may be controlled by the control logic 150 and may be configured to generate word line voltages to be supplied to the memory cell array 110, such as a read voltage, a program voltage, a pass voltage, a local voltage, a verification voltage, and the like. The control logic 150 may be configured to control an overall operation of the memory device 100.

The pass/fail checking circuit 160 may be configured to check program pass/fail based on data read by the page buffer circuit 120 at a program operation. The judgment result may be sent to the control logic 150. The control logic 150 may be configured to control a program sequence based on the judgment result of the pass/fail checking circuit 160. The pass/fail checking circuit 160 may be configured to check the program pass/fail in a wired-OR manner or a column scan manner. An example of a program pass/fail checking circuit is disclosed in U.S. Pat. No. 6,282,121 entitled “FLASH MEMORY DEVICE WITH PROGRAM STATUS DETECTION CIRCUITRY AND THE METHOD THEREOF”, the disclosure of which is incorporated herein by reference.

The input/output buffer circuit 180 may be configured to send data from the page buffer circuit 120 through the random data interface circuit 170 to an external device during a read operation. The input/output buffer circuit 180 may be configured to send data from the external device to the page buffer circuit 120 through the random data interface circuit 170 during a program operation. The input/output buffer circuit 180 may include an input buffer 181 configured to receive data from the external device and an output buffer 182 configured to output data to the external device.

The random data interface circuit 170 may be configured to randomize data received from the input/output buffer circuit 180 and to transfer the randomized data to the page buffer circuit 120. The random data interface circuit 170 may be configured to de-randomize data received from the page buffer circuit 120 and to transfer the de-randomized data to the input/output buffer circuit 180. The random data interface circuit 170 may be configured to selectively conduct data randomization under the control of the control logic 150. During a cache read operation, the random data interface circuit 170 may be configured to de-randomize data read out from the memory cell array 110 based on a seed value which is automatically generated within the memory device. This will be more fully described below.

The memory device 100 may operate responsive to a request from a memory controller. Although not illustrated in FIG. 1, the memory controller may include a processing unit, ECC, a buffer memory, and the like.

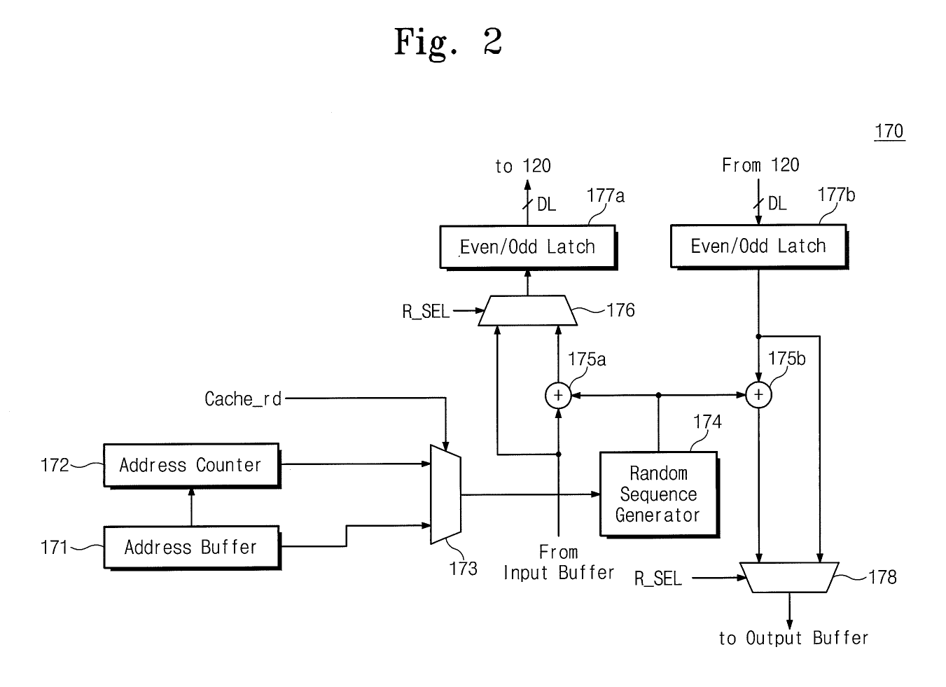

FIG. 2 is a block diagram schematically showing a random data interface circuit 170 in FIG. 1 in greater detail.

Referring to FIG. 2, a random data interface circuit 170 may include an address buffer 171, an address counter 172, a first multiplexer 173, a random sequence generator 174, first and second exclusive-OR (XOR) gates 175a and 175b, a second multiplexer 176, first and second even/odd latches 177a and 177b, and a third multiplexer 178.

The address buffer 171 may receive an externally applied address and send the received address to the address counter 172 and the first multiplexer 173. The address counter 172 may be configured to count the address from the address buffer 171. The address counter 172 may be configured to increment the address. The first multiplexer 173 may be configured to select one of the address from the address buffer 171 and an address from the address counter 172 in response to a cache read signal Cache_rd.

A cache read command may be used to sequentially read a plurality of pages of data without an input of an external address. On the other hand, a normal read command may be used to read one page of data in response to an input of an external address. A cache read operation may be made by firstly providing a normal read command with an initial address to a memory device and then sequentially providing a cache read command without an address to the memory device. The cache read signal Cache_rd may be activated when a cache read command is received. If a normal read command is received, the cache read signal Cache_rd may be inactivated. Accordingly, when the cache read signal Cache_rd is inactivated, the multiplexer 173 may transfer an address from the address buffer 171 to the random sequence generator 174. On the other hand, when the cache read signal Cache_rd is activated, the multiplexer 173 may transfer an address from the address counter 172 to the random sequence generator 174.

In some embodiments, it is possible to adjust a point of time when the cache read command is provided to the memory device.

When a normal read command is received, an initial address (for example, a page address, i.e., the starting address of a page of data in the memory cell array 110) may be provided to the address buffer 171. At the same time, the initial address in the address buffer 171 may be transferred to the address counter 172. The address counter 172 may increase the initial address by a given value so as to select a next page when a cache read command is received or when sensing of a current page is ended. Accordingly, when a cache read command is received, an address for selecting a next page may be provided as a seed from the address counter 172 to the random sequence generator 174 via the multiplexer 173.

In some embodiments, a row address (for example, a page address) may be provided to the address buffer 171. Alternatively, a column address or a combination of row and column addresses can be provided to the address buffer 171.

The random sequence generator 174 may be configured to generate random data. For example, the random sequence generator 174 may include a linear feedback signature register (LFSR). The random sequence generator 174 may be configured to generate random data based on an output of the first multiplexer 173, that is, an address that is provided as a seed value.

The first XOR gate 175a may perform an exclusive-OR operation with respect to random data from the random sequence generator 174 and data from an input buffer 181 in FIG. 1. The first XOR gate 175a may generate randomized data as a combination result in response to the data from the input buffer 181 and the random data from the random sequence generator 174. The second multiplexer 176 may select either the output of the first XOR gate 175a, that is, the randomized data, or data from the input buffer 181, in response to a random selection signal R_SEL. The random selection signal R_SEL may be activated when data randomization is established. This means that data being programmed is randomized. The random selection signal R_SEL may be inactivated when data randomization is not established. This means that data being programmed is not randomized.

In some embodiments, establishing of data randomization may be made according to the control of the control logic 150 at power-up. This may be accomplished by trim information which is stored in the memory cell array 110 or in a non-volatile register (for example, a fuse circuit) or is provided from an external device.

The first even/odd latch 177a may be configured to transfer data output from the second multiplexer 176 to a page buffer circuit 120. When the random selection signal R_SEL is activated, randomized data may be transferred to the page buffer circuit 120. When the random selection signal R_SEL is inactivated, non-randomized data (i.e., raw data directly from the input buffer 181) may be transferred to the page buffer circuit 120.

When a read operation is requested, the page buffer circuit 120 may read out data from the memory cell array 110. The data read by the page buffer circuit 120 may be provided through the second even/odd latch 177b to the second XOR gate 175b and the third multiplexer 178. The second XOR gate 175b may perform an exclusive-OR operation with respect to random data received from the random sequence generator 174 and data (for example, randomized data) received from the even/odd latch 177b, and may responsively output de-randomized data. The third multiplexer 178 may select either data from the even/odd latch 177b or data from the XOR gate 175b, that is, de-randomized data, in response to the random selection signal R_SEL. The selected data may be provided through an output buffer 182 in FIG. 1 to an external device.

According to some embodiments, it is possible to provide an address in the address counter 182 to the random sequence generator 174 regardless of the type of read command that is received. For example, when a normal read command is received, an initial address may be provided to the address counter 172 via the address buffer. The initial address in the address counter 172 may be provided to the random sequence generator 174. When a cache read command is received, the address counter 172 may increment a previously received address. An address thus generated may be provided to the random sequence generator 174.

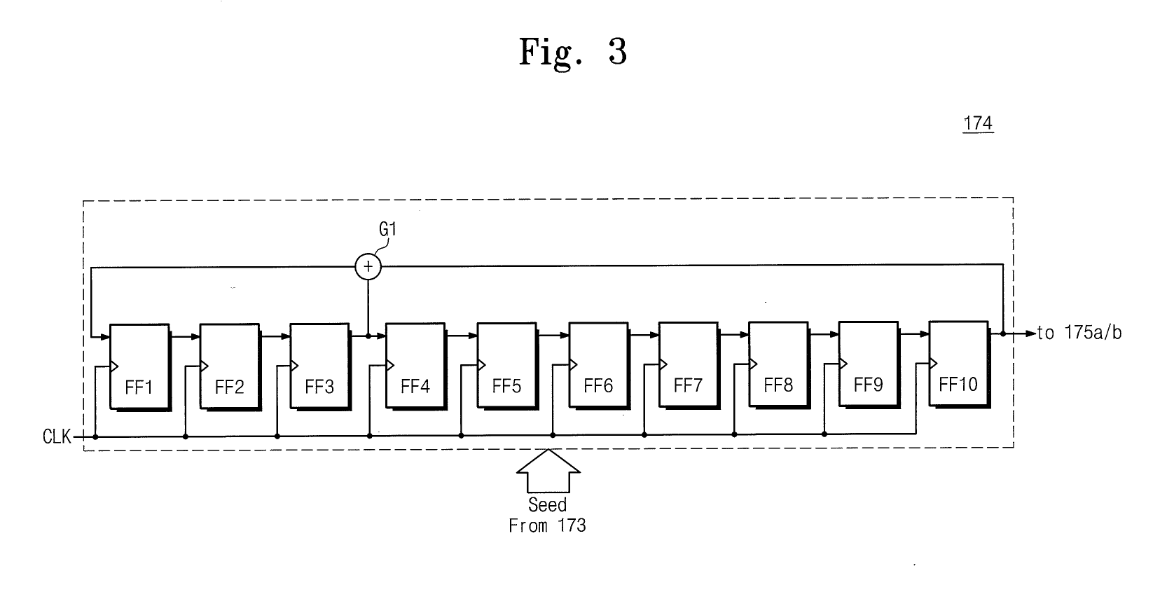

FIG. 3 is a block diagram schematically showing a random sequence generator according to some embodiments in greater detail.

Referring to FIG. 3, a random sequence generator 174 according to some embodiments may include a plurality of, for example, 10 flip-flops FF1˜FF10 and a XOR gate G1. In some embodiments, the random sequence generator 174 may include a linear feedback signature register LFSR. However, it will be appreciated that a random sequence generator can be implemented in many different ways. In general, an LFSR may be used as a device for generating a random data sequence. The random sequence generator 174 may generate a random data sequence in response to a seed and a clock signal, and may provide the random data to the first and second XOR gates 175a and 175b in FIG. 2.

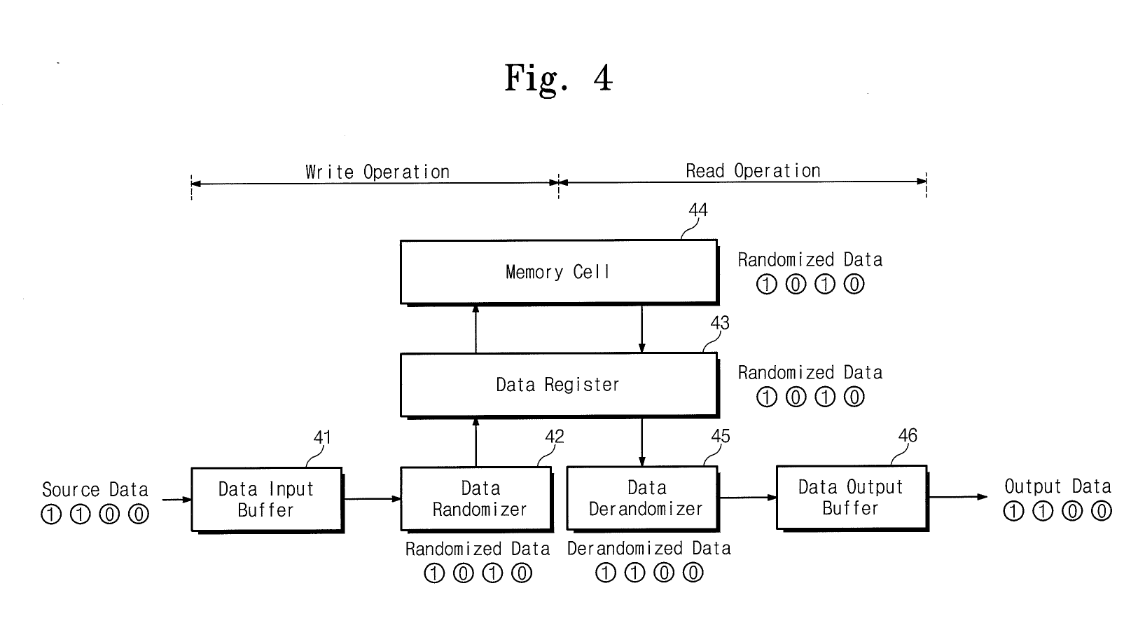

FIG. 4 is a diagram that illustrates randomization and de-randomization operations of a memory device according to some embodiments.

A write operation will be described under the assumption that data randomization is activated. A data input buffer 41 may receive source data of ‘1100’ from, for example, an external device. A data randomizer 42 may randomize the source data ‘1100’ and responsively output the randomized data ‘1010’ to a data register 43, which may correspond to the page buffer 120 of FIG. 1. Accordingly, a randomized source data sequence ‘1010’ may be stored in a memory cell array 44.

A read operation will be described under the assumption that data randomization is activated. Data stored in the memory cell array 43 may be read by the data register 43. The stored randomized data ‘1010’ read by the data register 43 may be de-randomized by a data de-randomizer 45 to generate the de-randomized data sequence ‘1100’. The de-randomized data may be provided through a data output buffer 46 to an external device.

In some embodiments, the data randomizer 42 and the data de-randomizer 45 may correspond to the random data interface circuit 170 shown in FIG. 2. In some embodiments, referring to FIGS. 2 and 4, the data randomizer 42 and the data de-randomizer 45 may be configured to share certain elements, such as the address buffer 171, the address counter 172, the first multiplexer 173, and the random sequence generator 174. The data randomizer 42 may further include the XOR gate 175a, the second multiplexer 176, and the even/odd latch 177a. The data de-randomizer 45 may further include the even/odd latch 177b, the XOR gate 175b, and the third multiplexer 178.

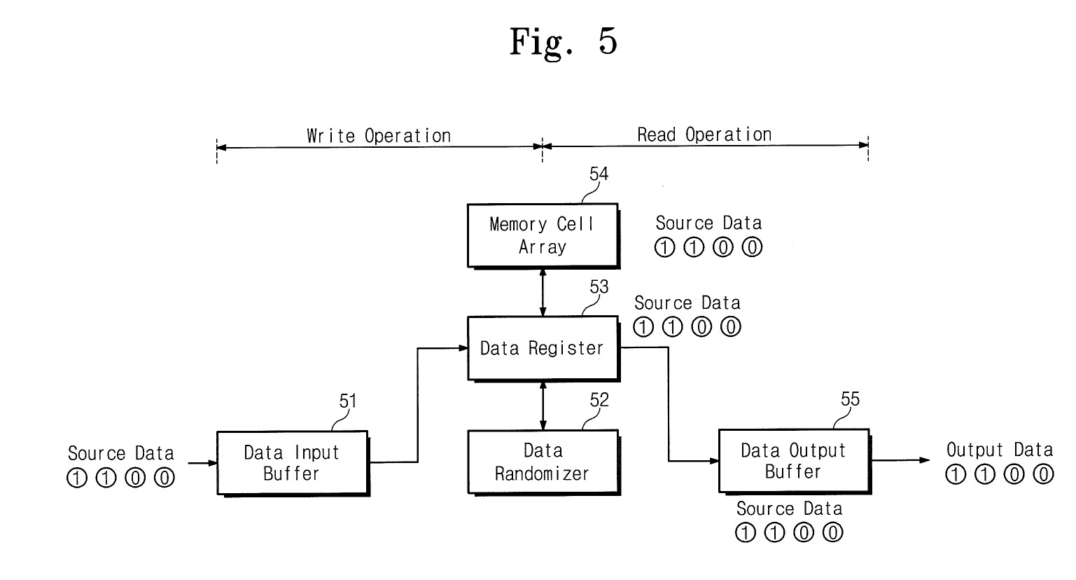

FIG. 5 is a diagram illustrating operations of a memory device according to some embodiments.

In the operations illustrated in FIG. 5, it is assumed that data randomization is not activated. Thus, a non-randomization write operation will be described with reference to FIG. 5. Source data ‘1100’ may be provided through a data input buffer 51 to a data register 53, without passing through a data randomizer 52. That is, no randomization may be conducted. The source data ‘1100’ may be stored in a memory cell array 54 by the data register 53.

A non-randomization read operation will now be described with reference to FIG. 5 under the assumption that data randomization is not activated. The data register 53 may read source data ‘1100’ from the memory cell array 54. The read source data ‘1100’ may be provided through a data output buffer 55 to an external device without undergoing a de-randomization process.

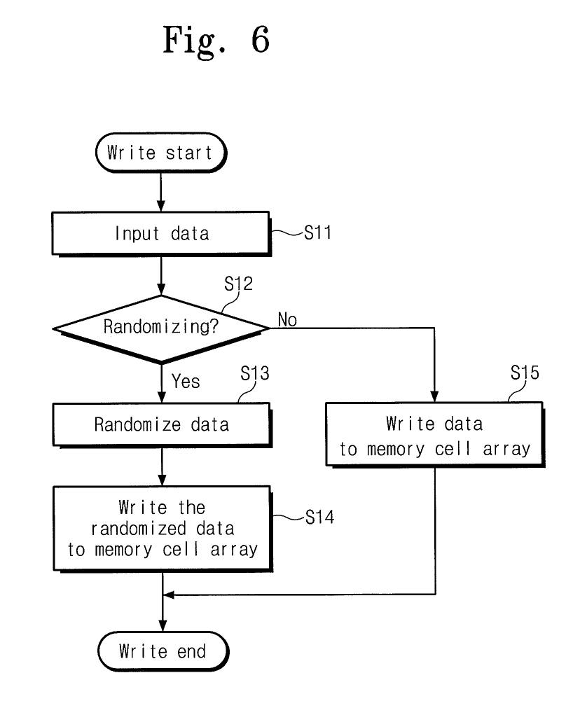

FIG. 6 is a flowchart illustrating write operations of a memory device according to some embodiments.

A write operation may include receiving data (S11), determining whether or not to randomize the received data (S12), randomizing the received data in response to a determination that data randomization is needed (S13), and writing the randomized data in a memory cell array 110 (S14). A write operation may further include writing the received data in the memory cell array without data randomization (S15).

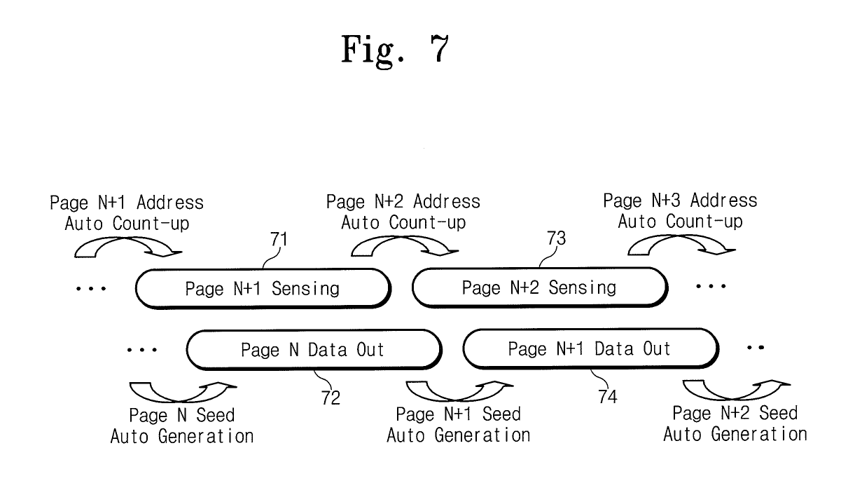

FIG. 7 is a flowchart illustrating read operations of a memory device according to some embodiments.

Referring to FIGS. 1, 2, and 7, the address buffer 171 may receive the nth page address. The address counter 172 may increment the received page address to the (n+1)th page address. The multiplexer 173 may transfer an output of the address counter 172 to the random sequence generator 174 in response a cache read signal Cache_rd.

In response to the address counter 172 generating the (n+1)th page address, the page buffer circuit 120 may sense the (n+1)th page of memory (71). At the same time, the page buffer circuit 120 may output the nth page data sensed at a previous cycle to the second even/odd latch 177b (72).

The address counter 172 may then increment the stored address to generate the (n+2)th page address, and the page buffer circuit 120 may sense the (n+2)th page (73). At the same time, the page buffer circuit 120 may output the (n+1)th page data sensed at a previous cycle to the second even/odd latch 177b (74). The page buffer circuit 120 may further include a latch circuit for storing the (n+1)th data while the (n+1)th page is sensed.

As understood from the above description, when a normal (i.e., non-cache) read command is received, the random sequence generator 174 may generate random data using an address provided from an external device as a seed. When a cache read command is received, the random sequence generator 174 may generate random data based on an address that is generated by an address counter 172 within the random data interface 170. Accordingly, in some embodiments, data read in response to a cache read command can be de-randomized using an address (that is, a seed) that is generated internally within the memory device.

A memory device according to some embodiments may be configured to randomize data that is being programmed into the memory and to de-randomize data that is read from the memory (that is, randomized data that is read from a memory cell array). This means that the interference between adjacent memory cells may be reduced. Further, the memory device may de-randomize randomized data even when a cache read command is received. This may be accomplished by using an address counter 172 that increments an initial address to generate an address that can be used as a seed to de-randomize the data.

Flash memory devices are nonvolatile memories that are capable of keeping data stored therein even without having power supplied to the memory. With the rapid increase in the use of mobile devices, such as cellular phones, personal digital assistants, digital cameras, portable gaming consoles, MP3 players, global positioning system (GPS) devices, and other devices, flash memory devices are becoming more widely employed for code storage, as well as data storage. Flash memory devices may be also utilized in home applications, such as high-definition TVs, digital versatile disks (DVDs), routers, and others.

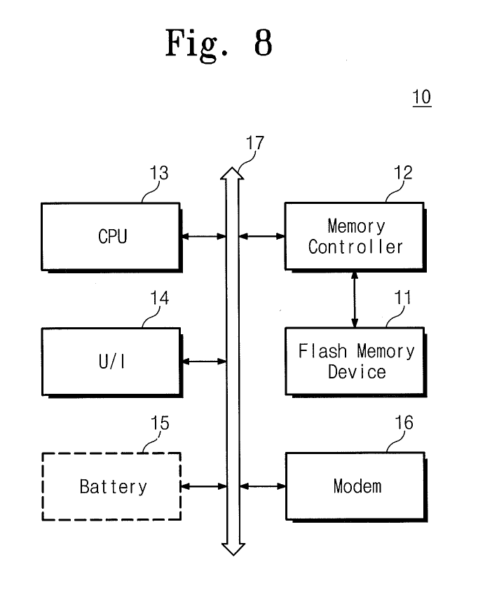

FIG. 8 is a block diagram schematically showing a computing system including a memory device according to some embodiments.

Referring to FIG. 8, the computing system 10 includes a flash memory device 11, a memory controller 12, a processing unit 13, such as a microprocessor or a central processing unit, a user interface 14, and a modem 16, such as a baseband chipset. The flash memory device 11 may be configured as shown FIG. 1 in substance. In the flash memory device 11, N-bit data (where N is a positive integer) to be processed by the processing unit 13 are stored through the memory controller 12. If the computing system shown in FIG. 8 is a mobile apparatus, it may further include a battery 15 for supplying power thereto.

Although not shown in FIG. 8, the computing system may be further equipped with other elements, such as an application chipset, a camera image processor (e.g., CMOS image sensor; CIS), a mobile DRAM, etc. The memory controller 12 and the flash memory device 11, for example, may constitute a solid state drive (SSD) which uses non-volatile memory to store data. An exemplary SSD is disclosed in U.S. Patent Publication No. 2006/0152981, the disclosure of which is incorporated herein by reference. Similarly, the flash memory device 11 and the memory controller 12 may constitute a memory card which uses non-volatile memory to store data.

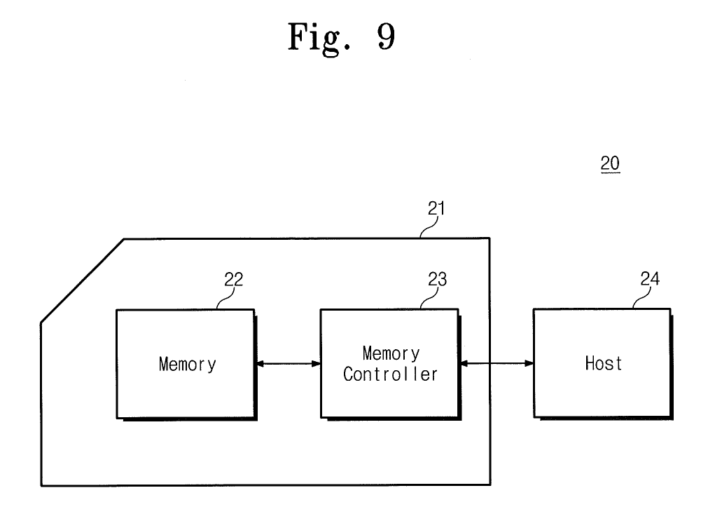

FIG. 9 is a block diagram schematically showing a memory-based storage device including a memory device according to some embodiments.

As illustrated in FIG. 9, a memory-based storage device 20 may include a card 21 which includes a memory 22 and a memory controller 23. For example, the card 21 may be a memory card such as a flash memory card. That is, the card 21 may be a card which satisfies any industry standard for use in electronic devices, such as digital cameras, personal computers, and the like. It is well comprehended that the memory controller 23 controls the memory 22 by the card 21 or based on control signals received from a host 24.

In the drawings and specification, there have been disclosed typical embodiments of the invention and, although specific terms are employed, they are used in a generic and descriptive sense only and not for purposes of limitation, the scope of the invention being set forth in the following claims.

What is claimed is:

1. A method of operating a non-volatile memory device, the method comprising:
randomizing source data to generate randomized source data;
storing the randomized source data in the non-volatile memory device;
generating a seed based on a memory address;
generating a random data sequence in response to the seed; and
de-randomizing the randomized source data using the random data sequence.

2. The method of claim 1, wherein the memory address comprises an address in the non-volatile memory device at which at least a portion of the randomized source data is stored.

3. The method of claim 2, wherein the memory address comprises a starting address in the non-volatile memory device of a page of the source data.

4. The method of claim 1, wherein the memory address is input to the memory device in connection with a cache read operation.

5. The method of claim 4, wherein generating the seed comprises incrementing the memory address.

6. The method of claim 5, wherein de-randomizing the randomized source data comprises performing an exclusive-OR operation on the randomized source data and the random data sequence.

7. A non-volatile memory device comprising:
a memory cell array configured to store data;
a page buffer circuit connected to the memory cell array; and
a random data interface circuit configured to increment an address input in connection with a cache read operation and to de-randomize stored data read by the page buffer circuit using the incremented address as a seed.

8. The non-volatile memory device of claim 7, further comprising an input/output buffer circuit configured to transfer source data received from an external device to the random data interface circuit and configured to receive de-randomized data from the random data interface circuit and to transfer the de-randomized data to the external device.

9. The non-volatile memory device of claim 8, wherein the random data interface circuit comprises:
a random sequence generator configured to generate a random data sequence in response to the incremented address;
a first XOR gate configured to randomize data received from the input/output buffer circuit using the random data sequence; and
a second XOR gate configured to de-randomize the randomized data using the random data sequence.

10. The non-volatile memory device of claim 7, wherein the address includes a row address, a column address, or a combination of row and column addresses.

11. The non-volatile memory device of claim 7, wherein the page buffer circuit includes a data latch configured to store data sensed from an (n−1)th page of data stored in the memory cell array while an nth page of data is output by the page buffer circuit to the random data interface circuit.

12. The non-volatile memory device of claim 11, wherein the data latch is configured to output the sensed data from the (n−1)th page of stored data to the random data interface circuit while the nth page of stored data is sensed from the memory cell array.

13. A method of reading data stored in a non-volatile memory device, the method comprising:
receiving a first read command and an initial address;
reading first data from a memory cell array in response to the initial address;
de-randomizing the first data using a first random data sequence generated in response to the initial address;
receiving a second read command;
generating an internal address based on the initial address;
reading second data from the memory cell array in response to the internal address; and
de-randomizing the second data using a second random data sequence generated in response to the internal address.

14. The method of claim 13, wherein the first read command is a non-cache read command and the second read command is a cache read command.

15. The method of claim 14, wherein generating an internal address and de-randomizing stored data are repeated in response to a subsequent cache read command, wherein a subsequent internal address is generated from a previously generated internal address.

16. The method of claim 15, wherein the cache read command is provided to the non-volatile memory device without an address.

17. The method of claim 13, further comprising sensing data corresponding to the internal address while data read according to the initial address is transferred to an external device.

18. The method of claim 17, wherein the external device comprises a memory controller together with the non-volatile memory device in a memory card or a solid state drive.
